(19) United States
(12) Patent Application Publication
(10) Pub. No.: US 2018/0183080 A1
(43) Pub. Date: Jun. 28, 2018

(54) FUEL CELL COOLING SYSTEM

(71) Applicant: DENSO CORPORATION, Kariya-city (JP)

(72) Inventor: Takashi YAMADA, Kariya-city (JP)

(21) Appl. No.: 15/810,515

(22) Filed: Nov. 13, 2017

(30) Foreign Application Priority Data
Dec. 26, 2016 (JP) 2016-251784

(51) Int. Cl. H01M 8/04701; H01M 8/04029; H01M 8/04007; H01M 8/0432; H01M 8/04746

(52) U.S. Cl. CPC H01M 8/04723; H01M 8/04029; H01M 8/04768; H01M 8/04358; H01M 8/04067

(57) ABSTRACT

A fuel cell cooling system includes a flow-volume ratio regulating valve adjusting a flow-volume ratio of a heat-dissipation flow volume of a coolant flowing into a fuel cell through a radiator and a bypass flow volume of the coolant flowing into the fuel cell by bypassing the radiator, a temperature sensor sensing a temperature of the coolant flowing out of the fuel cell, an inflow temperature control unit controlling an operation of the flow-volume ratio regulating valve and adjusting the temperature of the refrigerant flowing into the fuel cell such that a sensed temperature sensed by the temperature sensor approaches a target temperature, and an abnormality determining unit determining whether a circulation flow volume of the refrigerant is in an abnormal state, based on the sensed temperature sensed in an adjusting time period where the flow-volume ratio is adjusted without controlling the bypass flow volume to be zero.

### CROSS REFERENCE TO RELATED APPLICATION

This application is based on Japanese Patent Application No. 2016-251784 filed on Dec. 26, 2016, the disclosure of which is incorporated herein by reference.

### TECHNICAL FIELD

The present disclosure relates to a fuel cell cooling system which cools down a fuel cell.

### BACKGROUND

Since a fuel cell executing a power generation by a chemical reaction between a hydrogen gas and an air generates heat when executes the power generation, it is necessary that a cooling system circulates a refrigerant such as a coolant to the fuel cell to suppress an increasing of a temperature of the fuel cell.

In the above cooling system, the coolant may be leaked from a circulation passage of the coolant due to a damage of a pipe constituting the circulation passage, the fuel cell may be activated in a state where the increasing of the temperature of the fuel cell cannot be sufficiently suppressed, and the fuel cell may be deteriorated.

According to JP2002-164070A, in a cooling system, a liquid collecting unit is located on a bottom surface of a casing that receives a fuel cell. The cooling system senses a liquid level of the coolant stored in the liquid collecting unit and detects a leakage abnormality of the coolant.

### SUMMARY

However, in the cooling system according to JP2002-164070A, since a sensor that senses the liquid level and the liquid collecting unit are necessary, a configuration of a leakage abnormality detection becomes complicated. Further, the cooling system can detect the leakage abnormality only in a case where a leakage occurs in the casing. In other words, when a leakage occurs in a circulation passage out of the casing, the coolant is not stored in the liquid collecting unit, and then the leakage abnormality cannot be detected.

It is an object of the present disclosure to provide a fuel cell cooling system which can execute an abnormality detection by a simple constitution without being limited to a leakage at a specified position.

According to an aspect of the present disclosure, the fuel cell cooling system circulating a refrigerant in a fuel cell and a radiator and cooling down the fuel cell by controlling the radiator to dissipate a heat transmitted from the fuel cell to the refrigerant includes a flow-volume ratio regulating valve configured to adjust a flow-volume ratio of a heat-dissipation flow volume that is a flow volume of the refrigerant flowing into the fuel cell through the radiator and a bypass flow volume that is a flow volume of the refrigerant flowing into the fuel cell by bypassing the radiator, a temperature sensor configured to sense a temperature of the refrigerant flowing out of the fuel cell, an inflow temperature control unit configured to control an operation of the flow-volume ratio regulating valve and adjust the temperature of the refrigerant flowing into the fuel cell such that a sensed temperature that is the temperature sensed by the temperature sensor approaches a target temperature, and an abnormality determining unit configured to determine whether a circulation flow volume of the refrigerant is in an abnormal state where the circulation flow volume is smaller than a predetermined flow volume, based on the sensed temperature sensed in an adjusting time period that is a time period where the flow-volume ratio is adjusted without controlling the bypass flow volume to be zero.

When the heat dissipation quantity is insufficient for the heat generation quantity, all of the circulation flow volume flows into the radiator while the bypass flow volume is controlled to be zero, and the temperature of the refrigerant flowing out of the fuel cell is higher than the target temperature. When the heat dissipation quantity is sufficient for the heat generation quantity, a part of the circulation flow volume bypasses the radiator, and the temperature of the refrigerant flowing out of the fuel cell is adjusted to the target temperature. When the circulation flow volume of the refrigerant is remarkably small in the adjusting time period where the bypass flow volume is adjusted without controlling the bypass flow volume to be zero, the temperature of the refrigerant flowing out of the fuel cell is higher than the target temperature.

According to the present disclosure, the central processing unit determines whether the circulation flow volume of the refrigerant is in the abnormal state where the circulation flow volume is smaller than the predetermined flow volume, based on the temperature of the refrigerant sensed in the adjusting time period that is a time period where a temperature regulation is executed without controlling the bypass flow volume to be zero. Thus, it can be detected that the cell outlet temperature becomes remarkably high in the adjusting time period, and the abnormal state can be determined. Thus, a liquid collecting unit and a liquid level sensor that are necessary in a cooling system according to JP2002-164070A are unnecessary, and the abnormal state where the circulation flow volume becomes smaller due to the coolant leakage can be detected. Since the abnormal state can be detected when the leakage occurs at a part of the circulation passage, an abnormality detection can be achieved by a simple constitution without being limited to a leakage at a specified position.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a fuel cell cooling system according to a first embodiment of the present disclosure;

FIG. 2 is a flowchart showing an abnormality determining operation executed by an ECU shown in FIG. 1;

FIG. 3 is a block diagram showing a valve opening level calculation operation shown in FIG. 2;

FIG. 4 is a time chart showing parameters of when an abnormality determination is executed by the abnormality determining operation shown in FIG. 2;

FIG. 5 is a flowchart showing the abnormality determining operation according to a second embodiment of the present disclosure;

FIG. 6 is a time chart showing parameters of when the abnormality determination is executed by the abnormality determining operation shown in FIG. 5;

FIG. 7 is a flowchart showing the abnormality determining operation according to a third embodiment of the present disclosure; and

FIG. 8 is a time chart showing parameters of when the abnormality determination is executed by the abnormality determining operation shown in FIG. 7.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration in each embodiment is changed, the other parts of the configuration can be configured as the same as a prior embodiment. Further, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

### First Embodiment

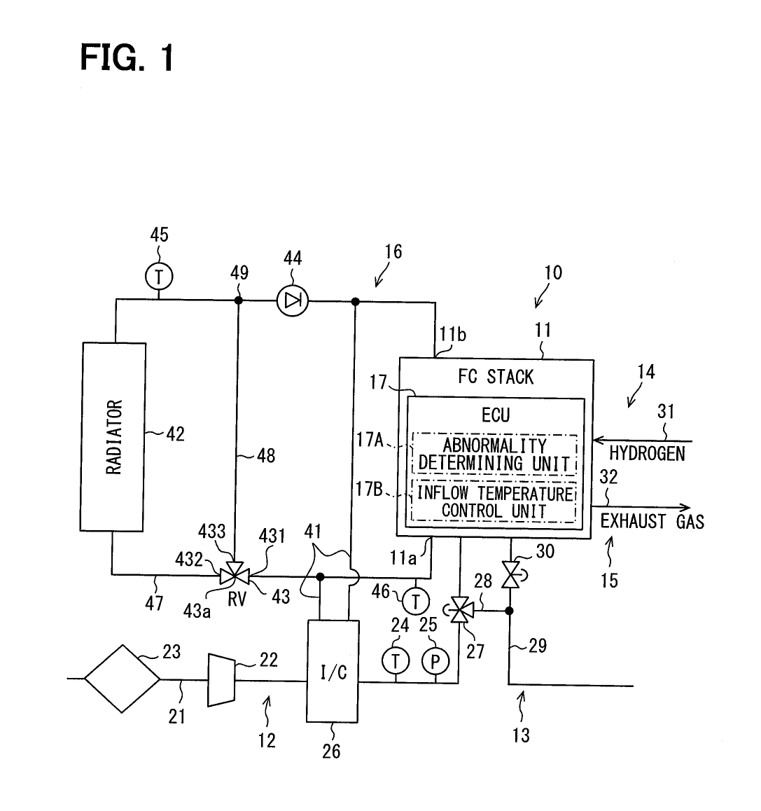

Referring to FIGS. 1 to 4, a first embodiment of the present disclosure will be described. A fuel cell system 10 is mounted to a fuel cell hybrid vehicle (FCHV) and supplies a power to a travelling motor.

As shown in FIG. 1, the fuel cell system 10 includes a fuel cell that is a FC stack 11, a cathode-gas supplying unit 12, a cathode-gas discharging unit 13, an anode-gas supplying unit 14, an anode-gas discharging unit 15 and a fuel cell cooling system. The cathode-gas supplying unit 12 supplies an air that is equivalent to a cathode gas to the fuel cell. The anode-gas supplying unit 14 supplies a hydrogen that is equivalent to an anode gas to the fuel cell. The fuel cell is a solid polymer fuel cell that generates a power by using an electrochemical reaction between the hydrogen and an oxygen that are supplied. The fuel cell that is the FC stack 11 includes cells having a structure that an electrolyte film is interposed between a plate of a cathode electrode and a plate of an anode electrode, and separators located between the cells.

The electrolyte film includes a solid polymer thin film having a good proton conductivity and a dryness level in a wet state. In the wet state, the electrolyte film has the good proton conductivity, and the FC stack 11 operates in a normal state without being disturbed. The electrodes are made of carbon. A platinum catalyst advancing a power generating reaction is supported at a boundary between the electrodes and the electrolyte film. The hydrogen that is equivalent to a reaction gas is supplied to power generating region of the cells through gas passages arranged in the cells.

The FC stack 11 includes an ECU 17 that is equivalent to an electronic control unit controlling the fuel cell. The ECU 17 is a control unit controlling components of the fuel cell system 10. The ECU 17 executes a program stored in a storage media to control the components. The ECU 17 includes at least one central processing unit (CPU) and the storage media storing the program and a data. According to the present embodiment, the ECU 17 is achieved by a microcomputer including a storage media that is readable by a computer. The storage media is a non-transitional substantial storage media that temporarily stores the program and the data that are readable by the computer. According to the present embodiment, the storage media is achieved by a semiconductor memory or a magnetic disc.

The cathode-gas supplying unit 12 includes a cathode-gas pipe 21, an air compressor 22, an air flowmeter 23, a temperature measuring unit 24, a pressure measuring unit 25, an intercooler (I/C) 26 and a three-way valve 27. The cathode-gas pipe 21 is a pipe connected with a cathode electrode terminal of the FC stack 11. The cathode electrode terminal is connected with the cathode electrodes of the cells. The air compressor 22 is a compressor connected with the FC stack 11 through the cathode-gas pipe 21, introduces and compresses an external air to into the air, and supplies the air to the FC stack 11 as the cathode gas.

The air flowmeter 23 is located upstream of the air compressor 22, measures a quantity of the external air introduced into the air compressor 22, and sends a measured value of the quantity to the ECU 17. The ECU 17 drives the air compressor 22 based on the measured value so as to control a supplying quantity that is a quantity of the air supplied to the FC stack 11.

The intercooler 26 is a heat exchanger that exchanges heat between a refrigerant flowing through a cooling circuit 16 and the air flowing in the cathode-gas pipe 21 at a position downstream of the air compressor 22 and cools down the air supplied to the FC stack 11. The pressure measuring unit 25 and the temperature measuring unit 24 are located downstream of the intercooler 26. The pressure measuring unit 25 measures a pressure of the cathode gas and sends a measured value of the pressure to the ECU 17. The temperature measuring unit 24 measures a temperature of the cathode gas and sends a measured value of the temperature to the ECU 17.

The three-way valve 27 is located downstream of the pressure measuring unit 25 and the temperature measuring unit 24. The three-way valve 27 is connected with a cathode exhaust-gas pipe 29 of the cathode-gas discharging unit 13 through a communication pipe 28. The three-way valve 27 normally communicates with an upstream part of the cathode-gas pipe 21 and a downstream part of the cathode-gas pipe 21 and supplies the air to the FC stack 11. When an abnormality of the fuel cell system 10 occurs, the three-way valve 27 does not supply the air to the FC stack 11, supplies the air to the communication pipe 28 to bypass the FC stack 11, and then introduces the air into the cathode exhaust-gas pipe 29.

The cathode-gas discharging unit 13 includes the cathode exhaust-gas pipe 29 and a pressure regulating valve 30. The cathode exhaust-gas pipe 29 is a pipe connected with the cathode electrode terminal of the FC stack 11 and discharges a cathode exhaust gas flowing through the FC stack 11 to an exterior of the fuel cell system 10. The pressure regulating valve 30 regulates a pressure of the cathode exhaust gas in the cathode exhaust-gas pipe 29. The ECU 17 controls an opening level of the pressure regulating valve 30 based on the measured value of the pressure measuring unit 25. The communication pipe 28 is connected with the cathode exhaust-gas pipe 29 downstream of the pressure regulating valve 30.

The anode-gas supplying unit 14 includes an anode-gas pipe 31 and a hydrogen tank that not shown. The hydrogen tank is connected with the FC stack 11 through the anode-gas pipe 31 and supplies the hydrogen filled in the hydrogen tank to the FC stack 11.

The anode-gas discharging unit 15 includes an anode exhaust-gas pipe 32 and a vapor-liquid separating unit that is not shown. The anode exhaust-gas pipe 32 is a pipe connected with an outlet of an anode electrode terminal of the FC stack 11 and the vapor-liquid separating unit and introduces an anode exhaust gas including non-reaction gas into the vapor-liquid separating unit. The anode electrode terminal is connected with the anode electrodes of the cells, and the non-reaction gas is a gas that is not used in the power generating reaction and includes the hydrogen and the oxygen. The vapor-liquid separating unit separates a vapor component and a liquid component included in the anode exhaust gas. The vapor-liquid separating unit introduces the vapor component into the anode-gas supplying unit 14 and discharges the liquid component to external.

As shown in FIG. 1, the fuel cell hybrid vehicle includes the cooling circuit 16 that is equivalent to a cooling unit that cools down the FC stack 11. The cooling circuit 16 is a refrigerant circuit circulating a coolant that is the refrigerant outside of the FC stack 11 such that the coolant flows out of the FC stack 11 and then flows back into the FC stack 11. The cooling circuit 16 is connected with a coolant outlet 11a of the FC stack 11 and a coolant inlet 11b. The cooling circuit 16 includes connection passages 41 connected with the intercooler 26 located in a pipe through which the air supplied to the FC stack 11 flows, and the cooling circuit 16 also functions as a cooling unit that cools down a supplied air.

The cooling circuit 16 further includes a radiator 42, a rotary valve 43 and a circulation pump 44 in addition of the intercooler 26. The cooling circuit 16 further includes a radiator outlet temperature sensor 45 as a first temperature sensor and a cell outlet temperature sensor 46 as a second temperature sensor. The radiator outlet temperature sensor 45 and the cell outlet temperature sensor 46 send sensed temperature information to the ECU 17. The fuel cell cooling system includes the rotary valve 43, the cell outlet temperature sensor 46 and the ECU 17.

The radiator outlet temperature sensor 45 is located in the cooling circuit 16 downstream of the radiator 42 and is located in the cooling circuit 16 upstream of the circulation pump 44 and a bypass passage 48. Thus, the radiator outlet temperature sensor 45 senses a temperature of the coolant right after the coolant is cooled down by the radiator 42 as a radiator outlet temperature ToutR.

The cell outlet temperature sensor 46 is located in the cooling circuit 16 downstream of the FC stack 11 and is located in the cooling circuit 16 upstream of the rotary valve 43 and the intercooler 26. Thus, the cell outlet temperature sensor 46 senses the temperature of the coolant right after the coolant is heated by the FC stack 11 as a cell outlet temperature Tout.

The FC stack 11 provides the power that is necessary in a travelling of the fuel cell hybrid vehicle. When the FC stack 11 generates the power, a heat quantity that is a quantity of a heat generated by the FC stack 11 is in a level the same as an internal combustion engine generates. Thus, the radiator 42 is arranged so as to cool down the FC stack 11. The radiator 42 is located in the cooling circuit 16 and is a heat discharger that discharges heat to external by exchanging heat between the coolant and the external air. The radiator 42 is a heat discharging exchanger that cools down the coolant heated by the FC stack 11. The radiator 42 is arranged in a front region of an engine room. The radiator 42 includes a blower fan that is not shown. The radiator 42 cools down the coolant by using a cooling air that is supplied by the blower fan.

The cooling circuit 16 further includes a heat discharging passage 47 through which the coolant flows to the radiator 42 and the bypass passage 48 through which the coolant flows by bypassing the radiator 42. The bypass passage 48 branches from the cooling circuit 16 at a branch point 43a that is located upstream of the radiator 42 in a coolant flow and joins the cooling circuit 16 at a junction point 49 that is located downstream of the radiator 42 in the coolant flow.

The rotary valve 43 is located at the branch point 43a in the cooling circuit 16 where the heat discharging passage 47 and the bypass passage 48 separate from each other, and the rotary valve 43 regulates dividing ratios of the coolant circulated by the circulation pump 44 and flowing through the heat discharging passage 47 and the bypass passage 48. A flow volume of the coolant flowing through the heat discharging passage 47 is referred to as a heat-dissipation flow volume, and a flow volume of the coolant flowing through the bypass passage 48 is referred to as a bypass flow volume. In other words, a total volume of the heat-dissipation flow volume and the bypass flow volume is a circulation flow volume of the circulation pump 44 and is an inflow volume that is a volume of the coolant flowing into the FC stack 11. The rotary valve 43 is equivalent to a flow-volume ratio regulating valve that regulates a flow-volume ratio between the heat-dissipation flow volume and the bypass flow volume.

The rotary valve 43 has a structure that a valve is rotatably received in a casing. The casing includes an inlet 431 through which the coolant flowing through the cell outlet temperature sensor 46 flows, a heat-dissipation outlet 432 that discharges the coolant to the heat-dissipation passage 47 and a bypass outlet 433 that discharges the coolant to the bypass passage 48.

The valve rotates in the casing to adjust a heat-dissipation opening level that is an opening level of a communication between the inlet 431 and the heat-dissipation outlet 432 and to adjust a bypass opening level that is an opening level of a communication between the inlet 431 and the bypass outlet 433. The rotary valve 43 is a three-way valve where the heat-dissipation opening level and the bypass opening level vary in association with each other. The ECU 17 controls a rotation position of the valve to adjust the flow-volume ratio between the heat-dissipation flow volume and the bypass flow volume.

Specifically, when the valve is rotated to a position that the heat-dissipation opening level is 100%, the bypass opening level becomes 0%. Thus, the heat-dissipation opening level is in a fully open state and the bypass opening level is in a fully closed state. When the valve is rotated to a position that the heat-dissipation opening level is 0%, the bypass opening level becomes 100%. Thus, the heat-dissipation opening level is in the fully closed state and the bypass opening level is in the fully open state. When the valve is rotated to a position that the heat-dissipation opening level is 50%, the bypass opening level becomes 50%. Thus, the heat-dissipation opening level is in a half opening state and the bypass opening level is in the half opening state. According to the present embodiment, the heat-dissipation opening level is referred to as a valve opening level.

The circulation pump 44 is located in the cooling circuit 16 downstream of the junction point 49 and located upstream of the FC stack 11 in the coolant flow. The circulation pump 44 is a pump that feeds and circulates the coolant in the cooling circuit 16. The circulation pump 44 may be a rotation type pump that an impeller is rotated in a pump housing to feed the coolant.

The ECU 17 controls supplying quantities of the hydrogen and the air that are supplied to the FC stack 11 to control a power generation quantity of the FC stack 11. Further, it is requested that a temperature of a cell included in the FC stack 11 is controlled to be in an optimal range that is predetermined so as to improve a power generation efficiency of the FC stack 11 and suppress a deterioration of the FC stack 11. Since the ECU 17 controls operations of the rotary valve 43 and the circulation pump 44, the ECU 17 controls a heat dissipation quantity of heat dissipated from the FC stack 11 to the coolant and controls the temperature of the cell of the FC stack 11 to be in the optimal range.

Specifically, since the ECU 17 controls the operation of the rotary valve 43, the ECU 17 adjusts the flow-volume ratio between the heat-dissipation flow volume and the bypass flow volume and executes a temperature regulation to adjust a cell inlet temperature Tin that is a temperature of the coolant flowing into the FC stack 11. Since the ECU 17 executes the temperature regulation, the ECU 17 controls the cell outlet temperature Tout to approach a target outlet temperature Ttrg. Since the cell outlet temperature Tout and a cell temperature that is the temperature of the cell of the FC stack 11 have a correlation that is high, the ECU 17 sets the target outlet temperature Ttrg of the cell outlet temperature Tout to a temperature where the cell temperature is in the optimal range, based on the correlation.

Further, since the ECU 17 controls the operation of the circulation pump 44, the ECU 17 executes a flow-volume regulation to adjust the circulation flow volume that is the flow volume of the coolant flowing into the FC stack 11. Since the ECU 17 executes the flow-volume regulation, the ECU 17 controls the dryness level of the electrolyte film to be in an optimal range. Then, the ECU 17 executes the temperature regulation to adjust the cell inlet temperature Tin according to the circulation flow volume that is adjusted. The central processing unit included in the ECU 17 controls the rotary valve 43 and adjusts the cell inlet temperature Tin. In this case, the central processing unit is equivalent to an inflow temperature control unit 17B shown in FIG. 1.

When the coolant is leaked from the cooling circuit 16 due to a damage of the pipe constituting the cooling circuit 16 or when the coolant is not supplied to the cooling circuit 16 at a manufacturing phase or a maintenance phase of the fuel cell hybrid vehicle, the FC stack 11 is insufficiently cooled. In this case, the central processing unit included in the ECU 17 determines whether the circulation flow volume of the coolant is in an abnormal state where the circulation flow volume is smaller than a predetermined flow volume. In this case, the central processing unit is equivalent to an abnormality determining unit 17A shown in FIG. 1.

When the abnormality determining unit 17A detects the abnormal state, the ECU 17 limits the power generation quantity of the FC stack 11 or a power supply quantity that is a quantity of the power supplied to the travelling motor so as to control the FC stack 11 in a fail safe mode where an increasing of the cell temperature is suppressed and the fuel cell hybrid vehicle travels. According to the present embodiment, when the abnormality determining unit 17A determines that the circulation flow volume is in the abnormal state, the abnormality determining unit 17A detects the abnormal state. When the abnormality determining unit 17A does not detect the abnormal state, the ECU 17 controls the FC stack 11 in a normal travelling mode where the power generation quantity of the FC stack 11 is equal to a request value and the fuel cell hybrid vehicle travels.

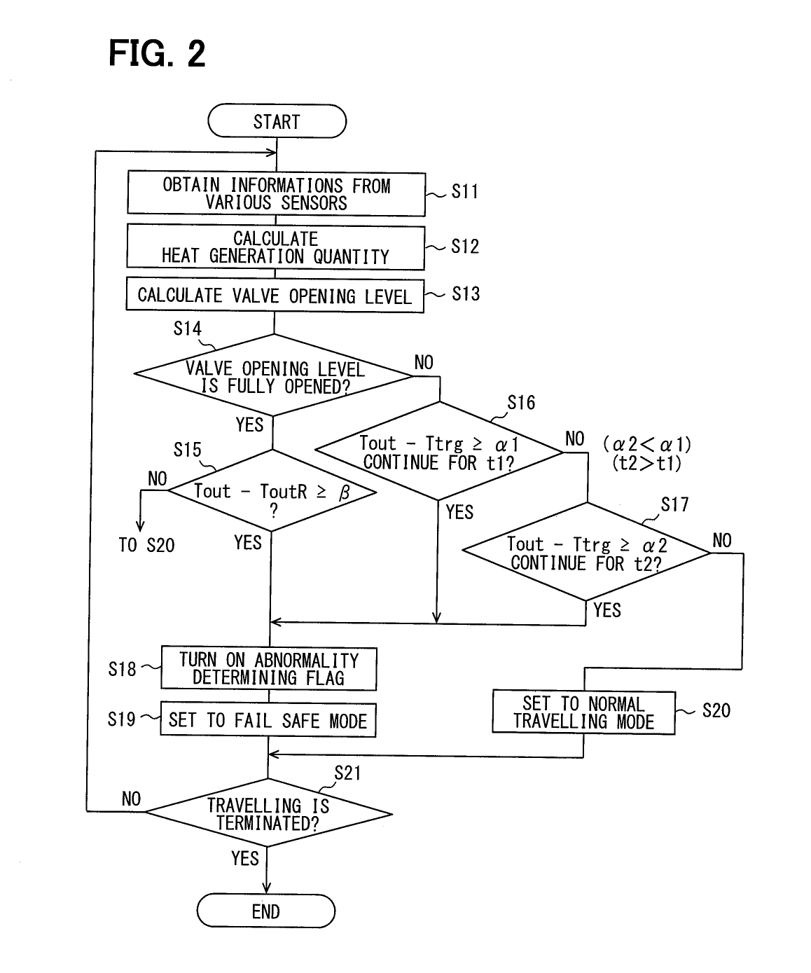

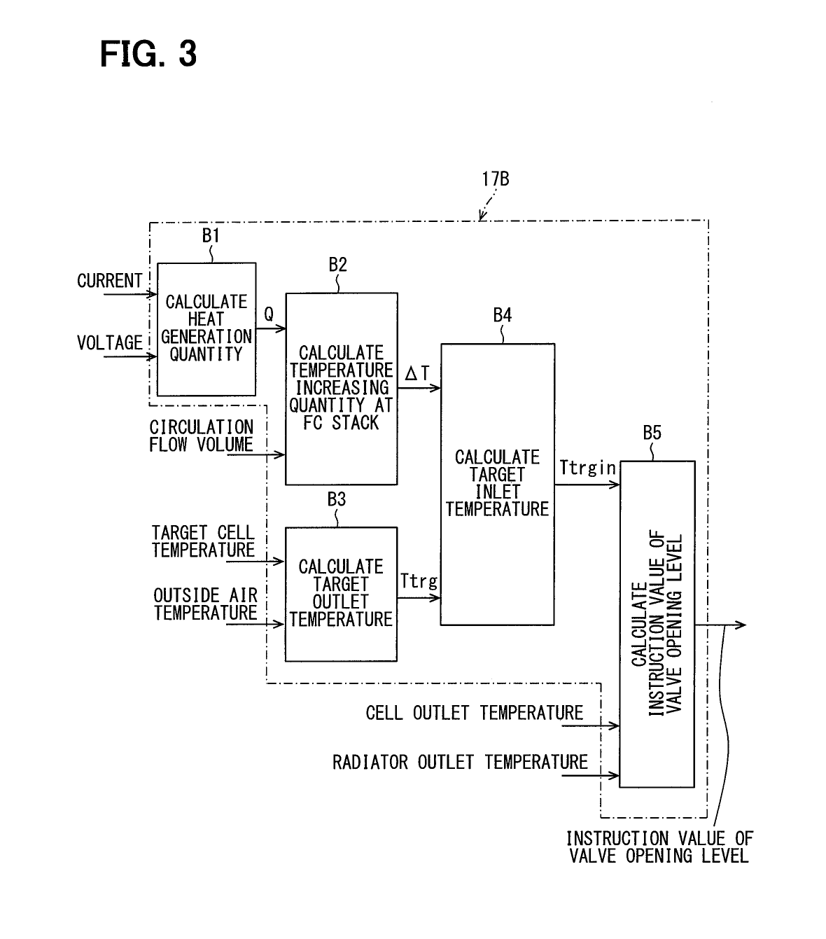

Referring to FIGS. 2 and 3, operations of the inflow temperature control unit 17B and the abnormality determining unit 17A will be described. The central processing unit of the ECU 17 executes a control shown in FIG. 2 in a time period where a power generation of the FC stack 11 is requested.

At S11, the central processing unit obtains informations from various sensors and then proceeds to S12. According to the present embodiment, the cell outlet temperature Tout that is sensed by the cell outlet temperature sensor 46 or the radiator outlet temperature ToutR that is sensed by the radiator outlet temperature sensor 45 may be inputted to the central processing unit as the informations. Further, an outside air temperature sensed by an outside air temperature sensor that is not shown, a current value of the FC stack 11 sensed by a current sensing circuit that is not shown, or a voltage value of the FC stack 11 sensed by a voltage sensing circuit that is not shown may be inputted to the central processing unit as the informations.

At S12, the central processing unit calculates the heat quantity that is the quantity of the heat generated when the FC stack 11 generates the power. Specifically, the central processing unit detects a current value and a voltage value of the power generated by the FC stack 11, and then calculates a heat generation quantity based on the detected values that are the current value and the voltage value. According to the present embodiment, the heat generation quantity is equivalent to the heat quantity. At S13, the central processing unit calculates the valve opening level of the rotary valve 43 based on the detected values obtained at S11 and the heat generation quantity calculated at S12. The inflow temperature control unit 17B calculates the valve opening level and outputs an opening level instruction signal indicating the valve opening level. The rotary valve 43 operates in response to the opening level instruction signal. The cell inlet temperature Tin is adjusted by an operation of the rotary valve 43. According to the present embodiment, the central processing unit executing S12 and S13 is the inflow temperature control unit 17B executing a calculation operation of a valve opening level.

FIG. 3 is a block diagram showing a valve opening level calculation operation executed by the inflow temperature control unit 17B. Each function block of the inflow temperature control unit 17B will be described. A first function block B1 calculates the heat generation quantity Q of the FC stack 11 based on the current value and the voltage value as the above description of S12. Specifically, the first function block B1 calculates the heat generation quantity Q to be increased in accordance with an increase in current value or a decrease in voltage value.

A second function block B2 calculates a temperature increasing quantity ΔT at the FC stack 11 based on the heat generation quantity Q that is calculated and the circulation flow volume of the circulation pump 44. Specifically, the second function block B2 calculates the temperature increasing quantity ΔT to be increased in accordance with an increase in heat generation quantity Q, and the second function block B2 calculates the temperature increasing quantity ΔT to be decreased in accordance with an increase in circulation flow volume. According to the present embodiment, the circulation flow volume may be calculated based on a power quantity supplied to the circulation pump 44.

A third function block B3 calculates the target outlet temperature Ttrg of the cell outlet temperature Tout of the coolant based on a target cell temperature and the outside air temperature. The target cell temperature is set to a value that the cell temperature is in the optimal range. The outside air temperature is a value sensed by the outside air temperature sensor, and is equivalent to an ambient temperature of an exterior of a chassis receiving plural cells. The cell outlet temperature Tout and the cell temperature have the correlation that is high. The correlation varies according to the outside air temperature. The third function block B3 calculates the target outlet temperature Ttrg based on the target cell temperature, the outside air temperature and the correlation. Further, the third function block B3 corrects the target outlet temperature Ttrg according to the current value of the FC stack 11, a history of the cell temperature, a dry state and a vehicle speed.

A fourth function block B4 calculates a target inlet temperature Ttrgin of the cell inlet temperature Tin of the coolant based on the temperature increasing quantity ΔT calculated by the second function block B2 and the target outlet temperature Ttrg calculated by the third function block B3. Specifically, the fourth function block B4 calculates the target inlet temperature Ttrgin to be decreased in accordance with a decrease in target outlet temperature Ttrg, and the fourth function block B4 calculates the target inlet temperature Ttrgin to be decreased in accordance with an increase in temperature increasing quantity ΔT.

A fifth function block B5 calculates an instruction value of the valve opening level based on the target inlet temperature Ttrgin calculated by the fourth function block B4, the cell outlet temperature Tout and the radiator outlet temperature ToutR. The cell outlet temperature Tout is a value sensed by the cell outlet temperature sensor 46, and the radiator outlet temperature ToutR is a value sensed by the radiator outlet temperature sensor 45. Further, the fifth function block B5 corrects the instruction value of the valve opening level according to a power consumption of vehicle electric devices, a temperature variation level of plural cells and the vehicle speed. The inflow temperature control unit 17B outputs the opening level instruction signal to control the rotary valve 43 to operate at the valve opening level calculated by the fifth function block B5.

According to the present embodiment, the inflow temperature control unit 17B calculates the instruction value of the valve opening level based on input values shown in FIG. 3. The input values include the current value and the voltage value of the FC stack 11, the circulation flow volume of the coolant, the target cell temperature, the outside air temperature, the cell outlet temperature Tout and the radiator outlet temperature ToutR.

At S14 shown in FIG. 2, the central processing unit determines whether the valve opening level calculated at S13 is fully opened after the instruction value of the valve opening level is calculated as shown in FIG. 3. In other words, the central processing unit determines whether heat-dissipation opening level is 100% after the instruction value of the valve opening level is calculated as shown in FIG. 3.

When the valve opening level is fully opened in a case where the heat generation quantity at the FC stack 11 is smaller than a heat dissipation quantity of the radiator 42, the cell temperature becomes lower than the target cell temperature. Thus, the valve opening level is adjusted to be in an opening level range where the valve opening level is not fully opened, and the cell inlet temperature Tin becomes higher than that of when the valve opening level is fully opened. When the valve opening level is fully opened in a case where the heat generation quantity at the FC stack 11 is larger than the heat dissipation quantity of the radiator 42, the cell temperature is still higher than the target cell temperature. Thus, the valve opening level is maintained to be fully opened. Thus, at S14, the central processing unit also determines whether the heat generation quantity is in a state where the heat generation quantity is smaller than the heat dissipation quantity and the cell inlet temperature Tin can be adjusted to a proper temperature. According to the present embodiment, a time period that the heat generation quantity is in a state where the cell inlet temperature Tin can be adjusted to the proper temperature and the valve opening level is not fully opened is referred to as an adjusting time period.

When the central processing unit determines that the valve opening level is fully opened at S14, the central processing unit determines that the cell inlet temperature Tin is in a state that the cell inlet temperature Tin cannot be adjusted to the proper temperature and proceeds to S15. At S15, the central processing unit determines whether the cell outlet temperature Tout is increased to be out of an estimated range. Specifically, the central processing unit calculates a first subtracting value by subtracting the radiator outlet temperature ToutR sensed by the radiator outlet temperature sensor 45 from the cell outlet temperature Tout sensed by the cell outlet temperature sensor 46, and then determines whether the first subtracting value is higher than or equal to a third predetermined value β. When the central processing unit determines that the first subtracting value is higher than or equal to the third predetermined value β, the central processing unit determines that the cell outlet temperature Tout is increased to be out of the estimated range and proceeds to S18. At S18, the central processing unit turns on an abnormality determining flag.

When the central processing unit determines that the valve opening valve is not fully opened at S14, the central processing unit determines that the cell inlet temperature Tin is in a state that the cell inlet temperature Tin can be adjusted to the proper temperature. In other words, the central processing unit determines that the cell inlet temperature Tin is in the adjusting time period. Then, the central processing unit proceeds to S16. At S16, the central processing unit determines whether the cell outlet temperature Tout is increased to be out of the estimated range in a short time period. Specifically, the central processing unit calculates a second subtracting value by subtracting the target outlet temperature Ttrg calculated by the third function block B3 from the cell outlet temperature Tout sensed by the cell outlet temperature sensor 46. Then, the central processing unit determines whether the second subtracting value is in a state where the second subtracting value is higher than or equal to a first predetermined value α1 for a time period longer than or equal to a first predetermined time period t1. In other words, the central processing unit determines whether a state where a divergence of the cell outlet temperature Tout relative to the target outlet temperature Ttrg is higher than or equal to the first predetermined value α1 continues for a time period longer than or equal to the first determined time period t1 in the adjusting time period.

When the central processing unit determines that the cell outlet temperature Tout is increased to be out of the estimated range in the short time period at S16, the central processing unit determines that the circulation flow volume of the refrigerant is in the abnormal state where the circulation flow volume is smaller than the predetermined flow volume and proceeds to S18. At S18, the central processing unit turns on the abnormality determining flag. When the central processing unit determines that the cell outlet temperature Tout is not increased to be out of the estimated range in the short time period at S16, the central processing unit proceeds to S17. At S17, the central processing unit determines whether the cell outlet temperature Tout is increased to be out of the estimated range for a long time period. Specifically, the central processing unit calculates a third subtracting value by subtracting the target outlet temperature Ttrg form the cell outlet temperature Tout, and then determines whether the third subtracting value is in a state where the third subtracting value is higher than or equal to a second predetermined value α2 for a time period longer than or equal to a second predetermined time period t2. In other words, the central processing unit determines whether a state where the divergence of the cell outlet temperature Tout relative to the target outlet temperature Ttrg is higher than or equal to the second predetermined value α2 continues for a time period longer than or equal to the second determined time period t2 in the adjusting time period.

According to the present embodiment, the second predetermined value α2 is set to be smaller than the first predetermined value α1, and the second predetermined time period t2 is set to be longer than the first predetermined time period t1. When the central processing unit determines that the cell outlet temperature Tout is increased to be out of the estimated range for the long time period at S17, the central processing unit determines that the circulation flow volume of the refrigerant is in the abnormal state where the circulation flow volume is smaller than the predetermined flow volume and proceeds to S18. At S18, the central processing unit turns on the abnormality determining flag. At S19, the central processing unit sets a mode of the fuel cell hybrid vehicle to the fail safe mode. According to the present embodiment, the first predetermined value α1 and the second predetermined value α2 are set to be smaller than the third predetermined value β.

The central processing unit executing S16 is equivalent to a determining unit or a first determining unit. The central processing unit executing S17 is equivalent to a second determining unit. In a first determination that is equivalent to S16, when the divergence is higher than or equal to the first predetermined value α1 in the short time period that is the first predetermined time period t1, a possibility that the coolant is leaked from a circulation passage is high and an abnormality is determined. When a damage of the circulation passage is slight and a leaked speed that is a speed of the coolant being leaked is low, the divergence does not become large in the short time period and is small in the long time period. In a second determination that is equivalent to S17, when the divergence is maintained for the second predetermined time period t2 that is the long time period in a case where the divergence is small and is equal to the second predetermined value α2, a possibility that the coolant is leaked while the damage of the circulation passage is slight and the abnormality is determined.

When the central processing unit determines that the cell outlet temperature Tout is not increased to be out of the estimated range for the long time period at S17, the central processing unit determines a normal state where a coolant leakage does not occur and proceeds to S20 without turning on the abnormality determining flag. At S20, the central processing unit sets the mode of the fuel cell hybrid vehicle to the normal travelling mode. According to the present embodiment, the coolant leakage is a leakage of the coolant. When the central processing unit sets the mode of the fuel cell hybrid vehicle to the fail safe mode at S19, the ECU 17 controls an operation of the fuel cell system 10 and controls to limit the power generation quantity. When the central processing unit sets the mode of the fuel cell hybrid vehicle to the normal travelling mode at S20, the ECU 17 controls the operation of the fuel cell system 10 and cancels a limitation of the power generation quantity.

At S19, the central processing unit increases a supply power to the circulation pump 44 and increases the circulation flow volume. The ECU 17 executes the flow-volume regulation to control the circulation flow volume, such that the ECU 17 controls the dryness level of the electrolyte film to be in the optimal range. The central processing unit executing S19 to increase the circulation flow volume is equivalent to an increasing volume control unit.

After the central processing unit sets the mode of the fuel cell hybrid vehicle at S19 or S20, the central processing unit proceeds to S21. At S21, the central processing unit determines whether a travelling of the fuel cell hybrid vehicle is terminated. When the central processing unit determines that the full cell hybrid vehicle is travelling at S21, the central processing unit returns to S11. When the central processing unit determines that the travelling of the fuel cell hybrid vehicle is terminated, the central processing unit terminates the present operation that is an abnormality determining operation. In other words, operations from S11 to S20 are repeatedly executed in a case where the fuel cell hybrid vehicle is travelling. In addition, when a driver is in the fuel cell hybrid vehicle while the vehicle speed is zero, the power generation of the FC stack 11 is requested. In this case, operations from S11 to S20 may be executed.

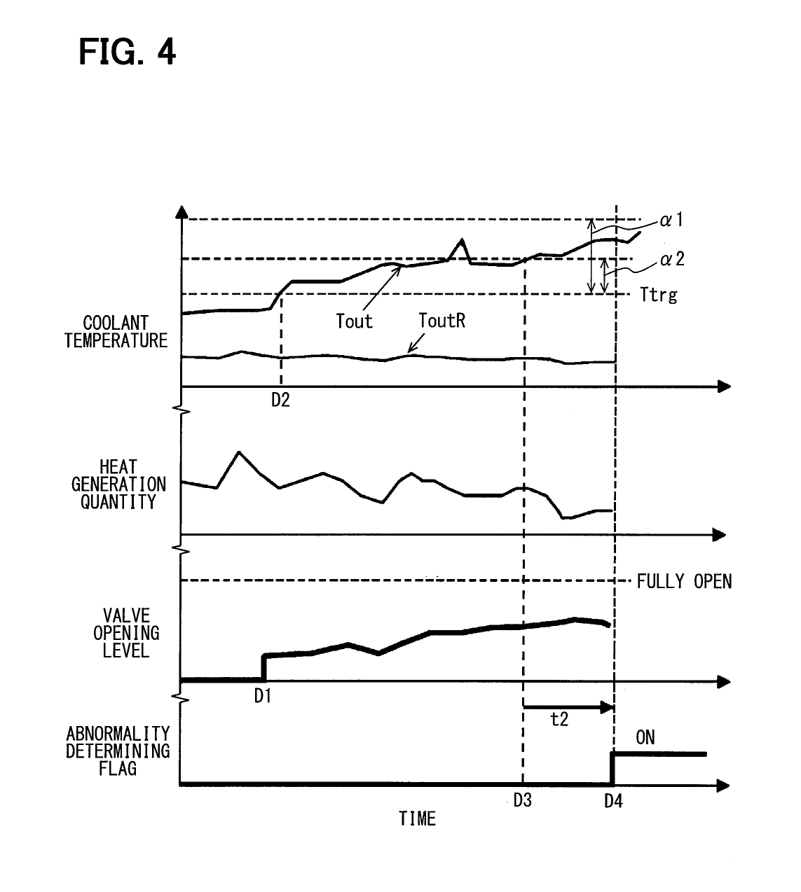

Next, referring to FIG. 4, parameters of when the abnormality determining flag is turned on while the central processing unit determines that the cell outlet temperature Tout is increased to be out of the estimated range for the long time period at S17 will be described.

As shown in FIG. 4, the horizontal axis indicates time and the vertical axis indicates the parameters including a coolant temperature, the heat generation quantity of the FC stack 11, the valve opening level and the abnormality determining flag. The coolant temperature includes the cell outlet temperature Tout and the radiator outlet temperature ToutR. As shown in FIG. 4, the leakage of the coolant occurs, and the circulation flow volume is smaller than the predetermined flow volume. Further, the adjusting time period where the cell inlet temperature Tin can be adjusted to the proper temperature and the valve opening level is not fully opened is determined.

At a time point D1, a control of the valve opening level starts while the circulation pump 44 is activated. Then, the cell outlet temperature Tout increases due to a shortage of the circulation flow volume. At a time point D2, the cell outlet temperature Tout is higher than the target outlet temperature Ttrg. Since the FC stack 11 is insufficiently cooled down due to the leakage of the coolant when the valve opening level is controlled according to a variation of the heat generation quantity, a state where the cell outlet temperature Tout is higher than the target outlet temperature Ttrg continues. At a time point D3, the cell outlet temperature Tout increases to a value that is a sum of the target outlet temperature Ttrg and the second predetermined value α2. At a time point D4, the central processing unit determines the third subtracting value is in the state where the third subtracting value is higher than or equal to the second predetermined value α2 for a time period longer than or equal to the second predetermined time period t2 at S17, and turns on the abnormality determining flag.

As the above description, the fuel cell cooling system includes the rotary valve 43 that is the flow-volume ratio regulating valve, the cell outlet temperature sensor 46 that is a temperature sensor, the inflow temperature control unit 17B and the abnormality determining unit 17A. The inflow temperature control unit 17B controls the operation of the rotary valve 43 to make the cell outlet temperature Tout sensed by the cell outlet temperature sensor 46 approach the target outlet temperature Ttrg and adjusts the cell inlet temperature Tin. The abnormality determining unit 17A determines whether the circulation flow volume of the refrigerant is in the abnormal state where the circulation flow volume is smaller than the predetermined flow volume, based on the cell outlet temperature Tout sensed in the adjusting time period. The adjusting time period is a time period where the flow-volume ratio of the heat-dissipation flow volume and the bypass flow volume is adjusted without controlling the bypass flow volume to be zero. In other words, the adjusting time period is a time period where the valve opening level is not fully opened.

When the heat dissipation quantity of the radiator 42 is sufficient for the heat generation quantity of the FC stack 11, the flow-volume regulation is executed without controlling the bypass flow volume to be zero and the cell outlet temperature Tout is adjusted to be the target outlet Ttrg. When the circulation flow volume of the refrigerant is remarkably small in the adjusting time period where the flow-volume regulation is executed, the cell outlet temperature Tout is higher than the target outlet temperature Ttrg.

According to the present embodiment, the central processing unit determines whether the circulation flow volume of the refrigerant is in the abnormal state where the circulation flow volume is smaller than the predetermined flow volume, based on the cell outlet temperature Tout sensed in the adjusting time period that is a time period where the temperature regulation is executed without controlling the bypass flow volume to be zero. Thus, it can be detected that the cell outlet temperature Tout becomes remarkably high in the adjusting time period, and the abnormal state can be determined. Thus, a liquid collecting unit and a liquid level sensor that are necessary in a cooling system according to JP2002-164070A are unnecessary, and the abnormal state where the circulation flow volume becomes smaller due to the coolant leakage can be detected. Since the abnormal state can be detected when the leakage occurs at a part of the circulation passage, an abnormality detection can be achieved by a simple constitution without being limited to a leakage at a specified position. Further, when the circulation flow volume becomes smaller due to a shortage of a charging quantity of the refrigerant in the circulation passage at a charging operation in a case where the leakage does not occur, the abnormal state can be detected.

According to the present embodiment, the abnormality determining unit 17A includes the determining unit that is equivalent to the central processing unit executing S16. In this case, the determining unit determines that the circulation flow volume is in the abnormal state when a state where a sensed temperature is higher than the target outlet temperature Ttrg by a value that is larger than or equal to the first predetermined value α1 continues for a time period longer than or equal to the first predetermined time period t1 in the adjusting time period.

When the circulation flow volume is close to zero, the cell outlet temperature sensor 46 substantially senses the outside air temperature. Thus, when the outside air temperature becomes lower, the cell outlet temperature Tout sensed in the abnormal state becomes lower. As a result, a control adjusting the cell inlet temperature Tin by adjusting the bypass flow volume without controlling the valve opening level to be fully opened is executed in a case where an actual cell temperature exceeds the optimal range and is high. According to the present embodiment, even when the outside air temperature is low, the determining unit determines that the circulation flow volume is in the abnormal state when a state where the sensed temperature is higher than the target outlet temperature Ttrg by a value that is larger than or equal to the first predetermined value α1 continues for a time period longer than or equal to the first predetermined time period t1 in the adjusting time period. Thus, when the outside air temperature is low, the abnormal state can be detected, and a reliability of a detection of the abnormal state can be improved.

According to the present embodiment, the abnormality determining unit 17A includes the first determining unit that is equivalent to the central processing unit executing S16 and the second determining that is equivalent to the central processing unit executing S17. The first determining unit determines that the circulation flow volume is in the abnormal state when a state where the sensed temperature is higher than the target outlet temperature Ttrg by a value that is larger than or equal to the first predetermined value α1 continues for a time period longer than or equal to the first predetermined time period t1 in the adjusting time period. The second determining unit determines that the circulation flow volume is in the abnormal state when a state where the sensed temperature is higher than the target outlet temperature Ttrg by a value that is larger than or equal to the second predetermined value α2 continues for a time period longer than or equal to the second predetermined time period t2 in the adjusting time period. The second predetermined value α2 is set to be smaller than the first predetermined value α1, and the second predetermined time period t2 is set to be longer than the first predetermined time period t1.

When a leaking speed of the refrigerant relative to a leakage abnormality is high, the divergence of the sensed temperature relative to the target outlet temperature Ttrg increases in a short time period. According to the present embodiment, the leaking speed of the refrigerant may be equivalent to the leaked speed of the coolant. When the leaking speed of the refrigerant is low, the divergence is slight and a state where the divergence is slight continues for a long time period. According to the present embodiment, since the first predetermined time period t1 is set to be short and the first predetermined value al is set to be large in the first determining unit, the first determining unit can rapidly detect the abnormal state in a case where the leaking speed is high. Since the second predetermined time period t2 is set to be long and the second predetermined value α2 is set to be small in the second determining unit, the second determining unit can detect the abnormal state in a case where the leaking speed is low. In this case, when the leaking speed is low, the first determining unit cannot detect the abnormal state.

According to the present embodiment, when the abnormality determining unit 17A determines that the circulation flow volume is in the abnormal state, the central processing unit executing S19 that is equivalent to the increasing volume control unit increases the circulation flow volume of the refrigerant flowing into the FC stack 11 through the circulation passage. Thus, since the circulation flow volume is increased, the divergence between the cell outlet temperature Tout and the target outlet temperature Ttrg remarkably occurs in a case where the circulation flow volume is in the abnormal state. A detecting accuracy of the abnormal state can be improved and the abnormal state can be reconfirmed. Since the circulation flow volume is increased, it can be suppressed that the cell temperature is increased according to the shortage of the circulation flow volume generated due to the refrigerant leakage.

### Second Embodiment

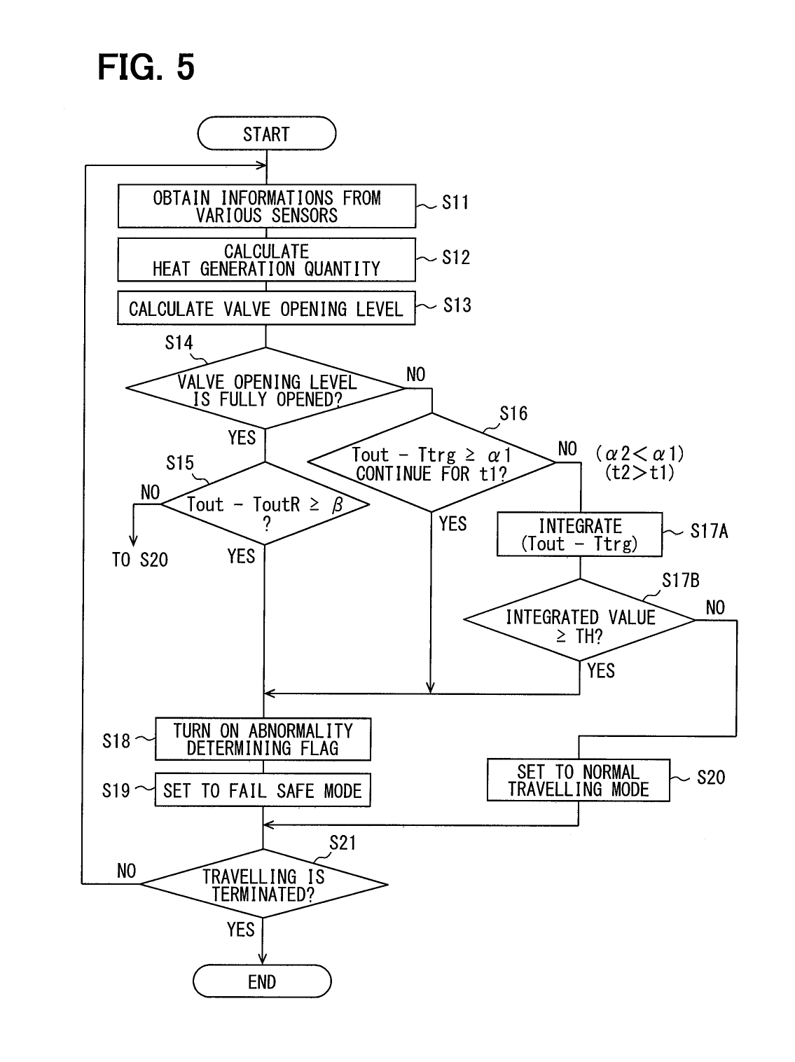

According to a second embodiment of the present disclosure, S17 shown in FIG. 2 is replaced by S17A and S17B shown in FIG. 5. When the central processing unit determines that the cell outlet temperature Tout is not increased to be out of the estimated range in the short time period at S16, the central processing unit executes S17A and then executes S17B.

At S17A, the central processing unit adds a value obtained by subtracting the target outlet temperature Ttrg from the cell outlet temperature Tout to a previous value as an integrated value. In this case, the previous value is the integrated value obtained in a previous cycle. When the central processing unit determines that the valve opening level is fully opened at S14 or when the central processing unit determines that the cell outlet temperature Tout is increased to be out of the estimated range in the short time period at S16, the central processing unit resets the integrated value. In other words, at S17A, when a state where the sensed temperature of the cell outlet temperature Tout is higher than the target outlet temperature Ttrg continues in the adjusting time period, the central processing unit integrates the divergence of the sensed temperature relative to the target outlet temperature Ttrg.

At S17B, the central processing unit determines whether the integrated value calculated at S17A is higher than or equal to a threshold TH that is predetermined. When the central processing unit determines that the integrated value is higher than or equal to the threshold TH, the central processing unit proceeds to S18. At S18, the central processing unit turns on the abnormality determining flag. At S19, the central processing unit sets the mode of the fuel cell hybrid vehicle to the fail safe mode. When the central processing unit determines that the integrated value is smaller than the threshold TH at S17B, the central processing unit proceeds to S20. At S20, the central processing unit sets the mode of the fuel cell hybrid vehicle to the normal travelling mode.

The central processing unit executing S17A is equivalent to a divergence integrating unit, and the central processing unit executing S17B is equivalent to an integration determining unit.

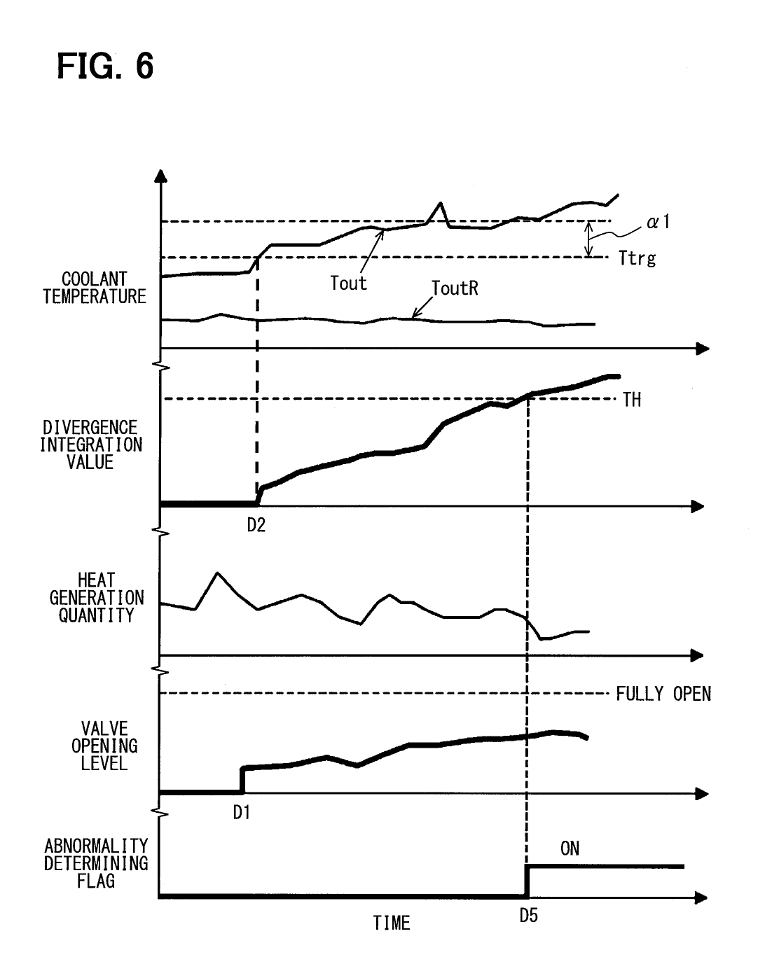

Next, referring to FIG. 6, parameters of when the abnormality determining flag is turned on while the central processing unit determines that the integrated value is higher than or equal to the threshold TH at S17B will be described.

As shown in FIG. 6, the horizontal axis indicates time and the vertical axis indicates the parameters including the coolant temperature, a divergence integration value, the heat generation quantity, the valve opening level and the abnormality determining flag. As shown in FIG. 6, the divergence integration value is added with respect to FIG. 4. The divergence integration value is the integrated value calculated at S17A. As shown in FIG. 6, similar to FIG. 4, the leakage of the coolant occurs, and the circulation flow volume is smaller than the predetermined flow volume.

At the time point D1, the control of the valve opening level starts, and the cell outlet temperature Tout increases due to the shortage of the circulation flow volume. At the time point D2, the cell outlet temperature Tout is higher than the target outlet temperature Ttrg. Then, the FC stack 11 is insufficiently cooled down due to the leakage of the coolant, and a state where the cell outlet temperature Tout is higher than the target outlet temperature Ttrg continues. At a time point D5, the divergence integration value increases to reach the threshold TH. In this case, the central processing unit determines that the integrated value is higher than or equal to the threshold TH at S17B, and turns on the abnormality determining flag.

As the above description, in the fuel cell cooling system according to the present embodiment, the abnormality determining unit 17A includes the divergence integrating unit that is equivalent to the central processing unit executing S17A and the integration determining unit that is equivalent to the central processing unit executing S17B. When a state where the sensed temperature of the cell outlet temperature Tout is higher than the target outlet temperature Ttrg continues in the adjusting time period, the divergence integrating unit integrates the divergence of the sensed temperature relative to the target outlet temperature Ttrg. When the divergence integration value integrated by the divergence integrating unit is higher than or equal to the threshold TH, the integration determining unit determines that the circulation flow volume is in the abnormal state. Thus, when the leaked speed of the coolant is high, the first determining unit that is equivalent to the central processing unit executing S16 can rapidly detect the abnormal state. When the leaked speed of the coolant is low, the integration determining unit can detect the abnormal state while the first determining unit cannot detect the abnormal state.

### Third Embodiment

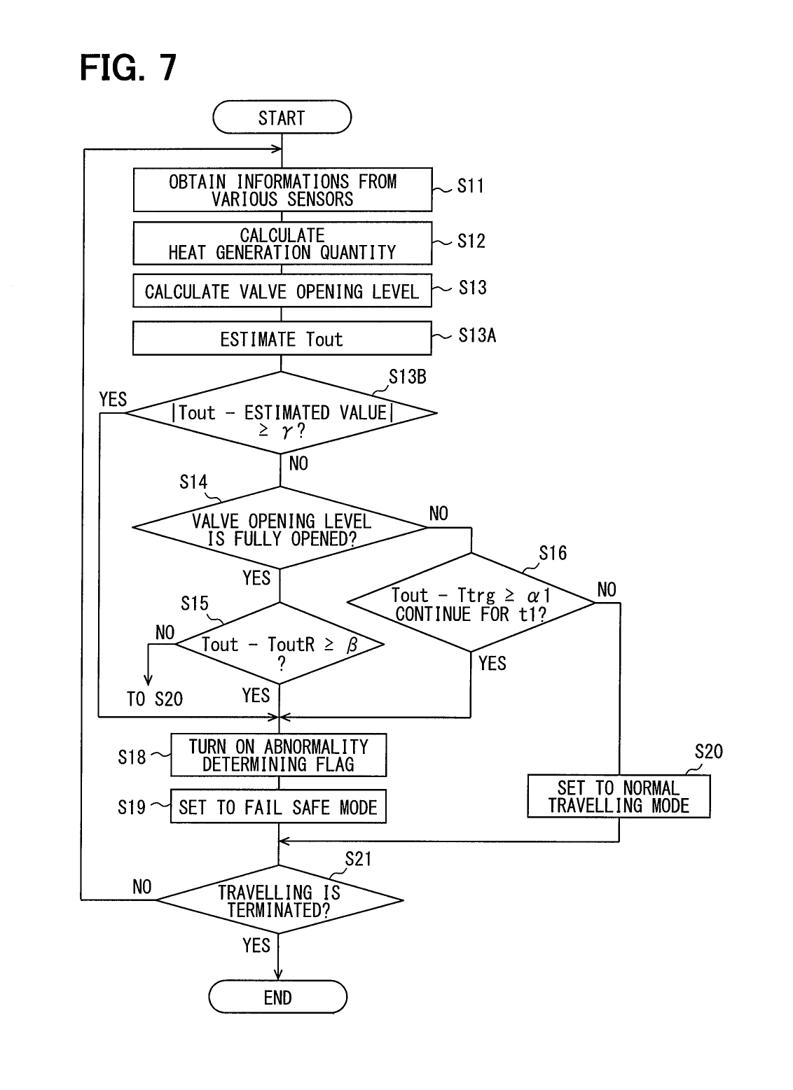

According to a third embodiment of the present disclosure, S13A and S13B shown in FIG. 7 are added to the abnormality determining operation shown in FIG. 2. Further, as shown in FIG. 7, the second determining unit that is equivalent to the central processing unit executing S17 in FIG. 2 is cancelled. After S13, the central processing unit estimates the cell outlet temperature Tout of the coolant at S13A as an estimated value. Specifically, according to the present embodiment, the central processing unit estimates the cell outlet temperature Tout based on the heat generation quantity of the FC stack calculated by the first function block B1 shown in FIG. 3, a sensed value of the cell outlet temperature Tout, the valve opening level and a cooling quantity calculated from the circulation flow volume.

At S13B, the central processing unit calculates a divergence of the estimated value relative to the sensed value, by subtracting the estimated value calculated at S13A from the sensed value of the cell outlet temperature Tout sensed by the cell outlet temperature sensor 46. Further, at S13B, the central processing unit determines whether an absolute value of the divergence that is calculated is higher than or equal to a predetermined temperature γ.

When the central processing unit determines that the absolute value is higher than or equal to the predetermined temperature γ, the central processing unit proceeds to S18. At S18, the central processing unit turns on the abnormality determining flag. At S19, the central processing unit sets the mode of the fuel cell hybrid vehicle to the fail safe mode. When the central processing unit determines that the absolute value is lower than the predetermined temperature γ, the central processing unit proceeds to S14.

The central processing unit executing S13A is equivalent to a temperature estimating unit, and the central processing unit executing S13B is equivalent to an estimation determining unit.

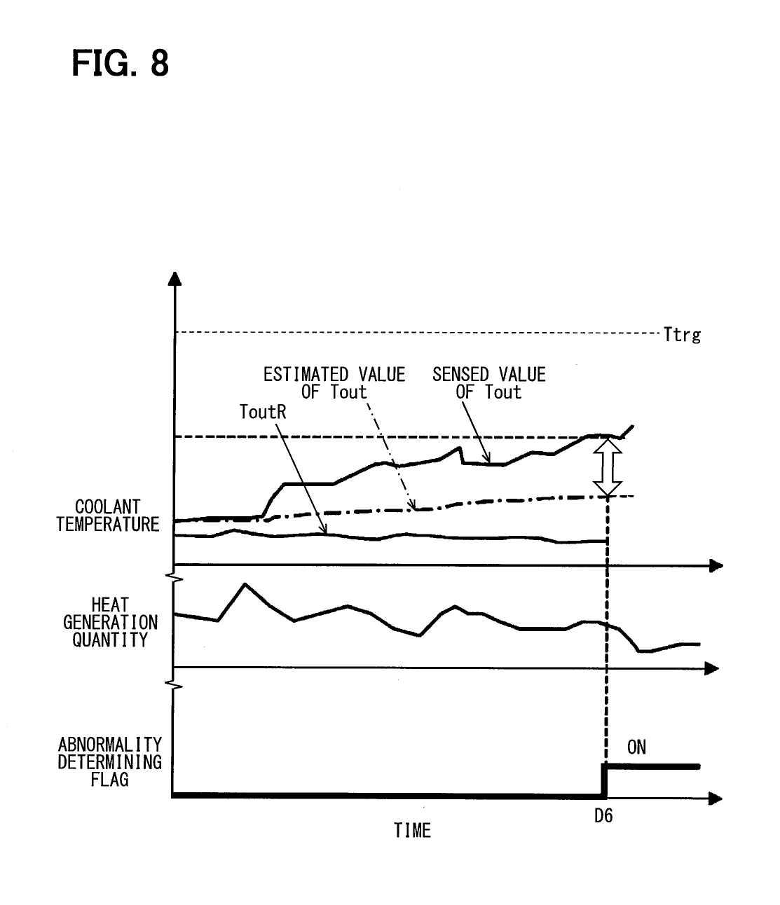

Next, referring to FIG. 8, parameters of when the abnormality determining flag is turned on while the central processing unit determines that the central processing unit determines that the absolute value is higher than or equal to the predetermined temperature γ at S13B will be described.

As shown in FIG. 8, the horizontal axis indicates time and the vertical axis indicates the parameters including the coolant temperature, the heat generation quantity and the abnormality determining flag. The coolant temperature includes the sensed value of the cell outlet temperature Tout sensed by the cell outlet temperature sensor 46, the estimated value of the cell outlet temperature Tout estimated by at S13A and a sensed value of the radiator outlet temperature ToutR. As shown in FIG. 8, similar to FIG. 4, the leakage of the coolant occurs. Further, the valve opening level is in the fully closed state where the heat-dissipation flow volume is zero, and the sensed value of the cell outlet temperature Tout is lower than the target outlet Ttrg.

Both the sensed value of the cell outlet temperature Tout and the estimated value of the cell outlet temperature Tout increase with time. When the leakage occurs, the sensed value increases faster than the estimated value does. Thus, a divergence of the sensed value relative to the estimated value increases with time, and the divergence reaches the predetermined temperature γ at a time point D6. In this case, the central processing unit determines that the absolute value is higher than or equal to the predetermined temperature γ at S13B, and turns on the abnormality determining flag.

Since the coolant is not completely disappeared while the circulation flow volume becomes smaller due to the leakage, the cell outlet temperature sensor 46 senses the temperature of the coolant. It is possible that the circulation flow volume becomes zero such that the coolant is completely disappeared. Specifically, when the leakage of the coolant continues for a long time period, or when the leaking speed is high due to a large damage in the pipe, or when a worker forgets to charge the coolant while the leakage does not occur, the circulation flow volume may become zero.

Since the cell outlet temperature sensor 46 senses a temperature of the air in the pipe, the sensed value of the cell outlet temperature Tout depends on an ambient temperature of the cell outlet temperature sensor 46. Thus, it is possible that the sensed value maintains to be smaller than the estimated value while the estimated value gradually increases as shown in FIG. 8. In this case, when the absolute value of the divergence of the estimated value relative to the sensed value becomes higher than or equal to the predetermined temperature y at S13B, the central processing unit turns on the abnormality determining flag at S18.

As the above description, in the fuel cell cooling system according to the present embodiment, the abnormality determining unit 17A includes the temperature estimating unit that is equivalent to the central processing unit executing S13A and the estimation determining unit that is equivalent to the central processing unit executing S13B. The temperature estimating unit estimates the temperature of the refrigerant flowing out from the FC stack 11. When a divergence of a sensed temperature relative that is the sensed value to an estimated temperature that is the estimated value is higher than or equal to the predetermined temperature γ, the estimation determining unit determines that the circulation flow volume is in the abnormal state.

In a start of the fuel cell cooling system, the cell temperature is lower than the optimal range, and the sensed value of the cell outlet temperature Tout is lower than the target outlet temperature Ttrg, as show in FIG. 8. In this case, since the cell outlet temperature Tout is lower than the first predetermined value α1 and the second predetermined value α2, the central processing unit at S16 or S17 shown in FIG. 2 cannot detect the abnormal state. According to the present embodiment, since the central processing unit estimates the cell outlet temperature Tout and determines that the circulation flow volume is in the abnormal state in case where the divergence between the estimated temperature and the sensed temperature is higher than or equal to the predetermined temperature γ, the central processing unit can detect the abnormal state when the sensed value of the cell outlet temperature Tout is lower than the target outlet temperature Ttrg. Thus, the central processing unit can rapidly detect the abnormal state without waiting until the cell outlet temperature Tout increases to reach the first predetermined value α1 and the second predetermined value α2.

According to the present embodiment, when the sensed value maintains to be lower than the estimated value due to a disappearance of the coolant while the estimated value gradually increases, the central processing unit can determine that the circulation flow volume is in the abnormal state by executing S13B.

### Other Embodiment

The present disclosure is not limited to the embodiments mentioned above, and can be applied to various embodiments within the spirit and scope of the present disclosure. However, the present disclosure is not limited to the above embodiment. The present disclosure can be applied to various embodiments within the spirit and scope of claims of the present disclosure.

According to the first embodiment, as shown in FIG. 3, the central processing unit controls the valve opening level such that the sensed value of the cell outlet temperature Tout of the refrigerant becomes the target outlet temperature Ttrg. An inlet temperature sensor sensing the cell inlet temperature Tin of the refrigerant may be provided, and the central processing unit may control the cell outlet temperature Tout to be a required temperature by controlling a sensed value of the cell inlet temperature Tin to be a target inlet temperature.

According to the above embodiments, it is preferable that the central processing unit identifies an abnormality determination executed by positive determinations at S16 and S17 or by positive determinations at S15 and S13B and stores the abnormality determining flag in a memory.

According to the above embodiments, the adjusting time period is a time period where the flow-volume ratio of the heat-dissipation flow volume and the bypass flow volume is adjusted without controlling the bypass flow volume to be zero. However, the adjusting time period may be a time period where the flow-volume ratio of the heat-dissipation flow volume and the bypass flow volume is adjusted without controlling the bypass flow volume and the heat-dissipation flow volume to be zero.

According to the present disclosure, the radiator outlet temperature sensor 45 shown in FIG. 1 may be cancelled, and the central processing unit may estimate the radiator outlet temperature ToutR based on the outside air temperature. According to the first embodiment shown in FIG. 1, the rotary valve 43 is used as the flow-volume ratio regulating valve. According to the present disclosure, other valves may be used as the flow-volume ratio regulating valve. Further, according to the first embodiment shown in FIG. 1, the rotary valve 43 is a three-way valve that is used as the flow-volume ratio regulating valve. According to the present disclosure, two two-way valves may be combined to constitute the flow-volume ratio regulating valve.

According to the first embodiment, in the circulation passage, the intercooler 26 is connected with the FC stack 11 in a parallel connection. However, the intercooler 26 may be connected with the FC stack 11 in a series connection. Alternatively, the connection passages 41 and the intercooler 26 show in FIG. 1 may be cancelled.

According to the first embodiment, the FC stack 11 is the solid polymer fuel cell. However, the FC stack 11 is not limited, and may be a phosphoric acid fuel cell or a molten carbonate fuel cell. According to the first embodiment, the cooling unit is equivalent to the cooling circuit 16. However, the cooling unit may be other cooling devices.

According to the present disclosure, the ECU 17 may be replaced or achieved by hardware or software or a combination of hardware and software. Further, the ECU 17 may communicate with other control devices that execute at least a part of the above operations. When the ECU 17 is achieved by an electronic circuit, the electronic circuit may be an analog circuit or a digital circuit including plural logic circuits.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fuel cell cooling system circulating a refrigerant in a fuel cell and a radiator and cooling down the fuel cell by controlling the radiator to dissipate a heat transmitted from the fuel cell to the refrigerant, the fuel cell cooling system comprising:
a flow-volume ratio regulating valve configured to adjust a flow-volume ratio of a heat-dissipation flow volume that is a flow volume of the refrigerant flowing into the fuel cell through the radiator and a bypass flow volume that is a flow volume of the refrigerant flowing into the fuel cell by bypassing the radiator;
a temperature sensor configured to sense a temperature of the refrigerant flowing out of the fuel cell;
an inflow temperature control unit configured to control an operation of the flow-volume ratio regulating valve and adjust the temperature of the refrigerant flowing into the fuel cell such that a sensed temperature that is the temperature sensed by the temperature sensor approaches a target temperature; and
an abnormality determining unit configured to determine whether a circulation flow volume of the refrigerant is in an abnormal state where the circulation flow volume is smaller than a predetermined flow volume, based on the sensed temperature sensed in an adjusting time period that is a time period where the flow-volume ratio is adjusted without controlling the bypass flow volume to be zero.

2. The fuel cell cooling system according to claim 1, wherein
the abnormality determining unit includes a determining unit configured to determine that the circulation flow volume is in the abnormal state in a case where a state that the sensed temperature is higher than the target temperature by a value that is larger than or equal to a predetermined value continues for a time period longer than or equal to a predetermined time period in the adjusting time period.

3. The fuel cell cooling system according to claim 1, wherein
the abnormality determining unit includes
a first determining unit configured to determine that the circulation flow volume is in the abnormal state when a state where the sensed temperature is higher than the target temperature by a value that is larger than or equal to a first predetermined value continues for a time period longer than or equal to a first predetermined time period, and
a second determining unit configured to determine that the circulation flow volume is in the abnormal state when a state where the sensed temperature is higher than the target temperature by a value that is larger than or equal to a second predetermined value continues for a time period longer than or equal to a second predetermined time period,
the second predetermined value is set to be smaller than the first predetermined value, and
the second predetermined time period is set to be longer than the first predetermined time period.

4. The fuel cell cooling system according to claim 1, wherein
the abnormality determining unit includes
a divergence integrating unit configured to integrate a divergence of the sensed temperature relative to the target temperature to obtain an integrated value when a state where the sensed temperature is higher than the target temperature continues in the adjusting time period, and
an integration determining unit configured to determine that the circulation flow volume is in the abnormal state when the integrated value obtained by the divergence integrating unit is higher than or equal to a threshold that is predetermined.

5. The fuel cell cooling system according to claim 1, wherein
the abnormality determining unit includes
a temperature estimating unit configured to estimate the temperature of the refrigerant flowing out of the fuel cell as an estimated temperature, and
an estimation determining unit configured to determine that the circulation flow volume is in the abnormal state when an absolute value of a divergence of the sensed temperature relative to the estimated temperature estimated by the temperature estimating unit is higher than or equal to a predetermined temperature.

6. The fuel cell cooling system according to claim 1, further comprising:
an increasing volume control unit configured to increase the circulation flow volume of the refrigerant when the abnormality determining unit determines that the circulation flow volume is in the abnormal state.
